(19) United States
(12) Patent Application Publication
(10) Pub. No.: US 2026/0099937 A1
(43) Pub. Date: Apr. 9, 2026

(54) CLOUD MEASURING SYSTEM AND CLOUD HEIGHT MEASURING METHOD

(71) Applicant: Hitachi, Ltd., Tokyo (JP)

(72) Inventor: Akinobu WATANABE, Tokyo (JP)

(21) Appl. No.: 19/230,457

(22) Filed: Jun. 6, 2025

(30) Foreign Application Priority Data
Jun. 12, 2024 (JP) 2024-094924

(51) Int. Cl. G06T 7/593; G06T 7/60; H04N 23/69; H04N 23/695

(52) U.S. Cl. CPC G06T 7/593; G06T 7/60; H04N 23/69; H04N 23/695; G06T 2207/10012

(57) ABSTRACT

A cloud measuring system includes: a stereo camera capturing stereo images by cameras each changing pan and tilt angles; a camera control section controlling the pan and tilt angles to control imaging; a reception section receiving the stereo images; a matching coordinate acquisition section acquiring a feature point of an object in the stereo images, and acquiring, as matching coordinates, a combination of reference coordinates where the feature point is to be located in the images, and coordinates of the acquired feature point; a difference detection section acquiring a displacement amount of the feature point from the matching coordinates, acquiring direction difference amounts in pan and tilt directions from the displacement amount, and generating correction information; a correction processing section correcting the stereo images on the basis of the correction information; and a height estimation section estimating a cloud height on the basis of the corrected stereo images.

### CROSS-REFERENCE TO RELATED APPLICATION

This application claims priority to Japanese Patent Application No. 2024-094924 filed on Jun. 12, 2024, the entire contents of which are incorporated herein by reference.

### BACKGROUND OF THE INVENTION

### 1. Field of the Invention

The present invention relates to a cloud measuring system for measuring a state of a cloud in the sky, and a cloud height measuring method of this system.

### 2. Description of the Prior Art

It is necessary to acquire weather information around an airport as sequentially changeable information to control takeoff and landing of aircrafts at the airport. A meteorological aerodrome report (METAR) is a type of weather reports for reporting aviation weather information, and has been used to recognize weather conditions of airports, airbases, and the like.

METAR includes information associated with respective observation items, such as wind directions, wind velocities, visibilities, climates, and cloud heights. However, measurement of cloud heights in these observation items is particularly carried out on the basis of experiences of observers, and automation is less-advanced for this measurement. Meanwhile, a ceilometer which uses a laser is known as a conventional cloud measuring system, for example. The ceilometer is capable of measuring a height of a cloud immediately above, but incapable of measuring cloud heights in the whole sky due to a narrow measurable range in the horizontal direction.

For example, as a technology associated with this cloud height measurement, JP-2019-60754-A discloses measurement of cloud heights in a wide range with use of optical images captured by a stereo camera which includes a pair of wide-angle cameras directed to the zenith.

JP-2019-60754-A describes camera calibration carried out on the basis of stars contained in images captured during clear nighttime to correct a camera lens distortion. According to the technology described in JP-2019-60754-A, however, correction can be made only during clear nighttime since it is based on stars. Moreover, according to JP-2019-60754-A, the camera is fixed in a direction toward the zenith. This technology does not discuss directional deviation and the like of the camera, which may be produced with aging or for other reasons, when the camera is of a type capable of changing an imaging direction with use of a movable camera platform, for example.

### SUMMARY OF THE INVENTION

The present invention has been developed in consideration of the aforementioned circumstance. An object of the present invention is to achieve highly accurate measurement of cloud heights for a long period.

For achieving the above object, a cloud measuring system according to a preferred mode of the present invention includes: a stereo camera that includes a plurality of cameras each capable of changing an angle in a pan direction and an angle in a tilt direction, and captures stereo images that include a plurality of images having disparity between each other; a camera control section that controls the angle in the pan direction and the angle in the tilt direction for each of the plurality of cameras to control capture of the stereo images by the stereo camera; a reception section that receives the stereo images from the stereo camera; a matching coordinate acquisition section that acquires a feature point of an object contained in the stereo images, and acquires, as matching coordinates, a combination of reference coordinates where the feature point of the object is expected to be located in the stereo images, and coordinates of the feature point of the object, the feature point being acquired in the stereo images; a difference detection section that acquires a displacement amount of the feature point in the stereo images on the basis of the matching coordinates, acquires a direction difference amount in each of the pan direction and the tilt direction for at least one of the plurality of cameras on the basis of the displacement amount, and generates correction information; a correction processing section that corrects the stereo images on the basis of the correction information; and a height estimation section that estimates a ceiling of a cloud contained in the stereo images on the basis of the stereo images corrected by the correction processing section.

The present invention achieves highly accurate measurement of cloud heights in the whole sky. Other novel characteristics of the present invention and technical problems solved by these characteristics will become apparent in the light of following description in the present specification and the accompanying drawings.

### BRIEF DESCRIPTION OF THE DRAWINGS

FIG. 1 is a schematic diagram illustrating a configuration of a cloud measuring system according to an embodiment of the present invention;

FIG. 2 is a block diagram illustrating a simplified configuration of a cloud height measuring device;

FIG. 3 is a conceptual diagram illustrating weather information stored in a weather information retention section;

FIG. 4 is a flowchart illustrating an example of a cloud height measuring process;

FIG. 5 is a data configuration diagram illustrating an example of an imaging order table;

FIG. 6 is a data configuration diagram illustrating an example of a correction table;

FIG. 7 is a flowchart illustrating a flow of an imaging process;

FIG. 8 is a flowchart illustrating a flow of an object detection process;

FIG. 9 is a schematic diagram for explaining an example of a fixed object table;

FIG. 10 is a schematic diagram for explaining an outline of a matching process;

FIG. 11 is a flowchart illustrating a flow of a cloud shape recognition process;

FIG. 12 is a flowchart illustrating a flow of a direction deviation calculation process;

FIG. 13 is a flowchart illustrating a flow of a correction process;

FIG. 14 is a flowchart illustrating a flow of a cloud height estimation process; and

FIG. 15 is a conceptual diagram illustrating an example of METAR which is a type of weather reports.

### DESCRIPTION OF THE PREFERRED EMBODIMENT

An embodiment according to the present invention will be hereinafter described with reference to the drawings. The embodiment described hereinafter will be presented only as an example for explaining the present invention. It should be noted that omission and simplification are made as necessary for clarifying the explanation.

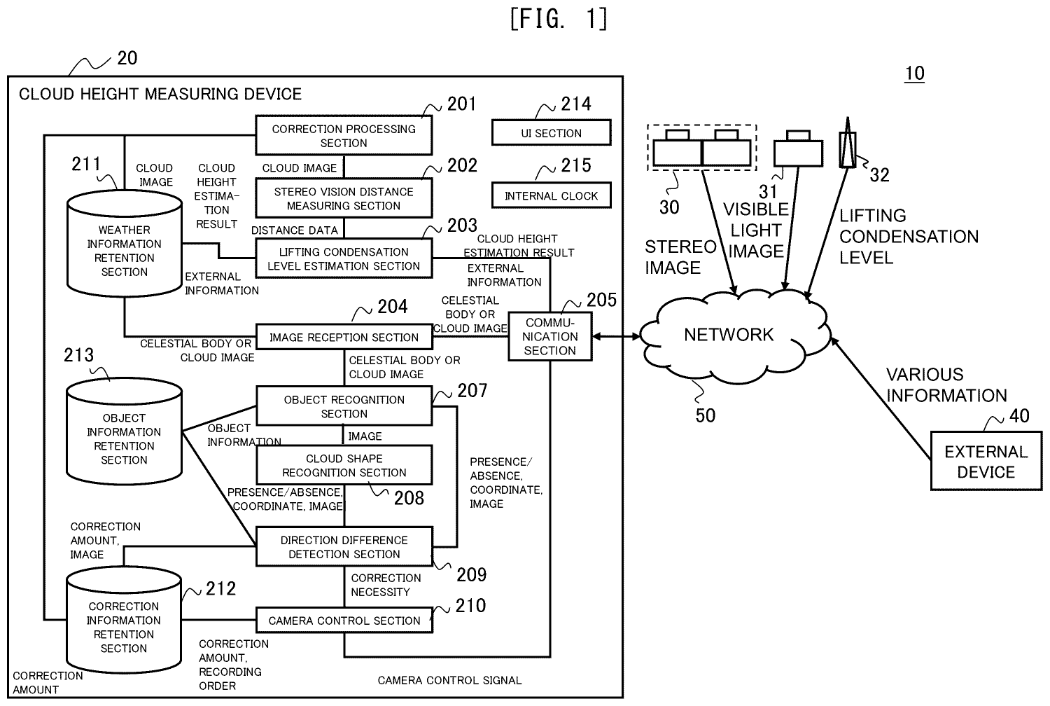

FIG. 1 is a schematic diagram illustrating a configuration of a cloud measuring system 10 according to an embodiment of the present invention.

The cloud measuring system 10 includes a cloud height measuring device 20, a stereo camera 30, a visible light camera 31, a ceilometer 32, and an external device 40. The cloud height measuring device 20 is connected to the stereo camera 30, the visible light camera 31, the ceilometer 32, and the external device 40 via a network 50. For example, the network 50 is a bidirectional communication network as represented by the Internet. The stereo camera 30, the visible light camera 31, and the ceilometer 32 are disposed at a measuring spot such as an airport. Note that the cloud height measuring device 20, the stereo camera 30, the visible light camera 31, and the ceilometer 32 may be directly connected to each other via a dedicated cable, for example, without using the network 50.

The cloud height measuring device 20 calculates a height of a cloud (cloud height) existing in the sky on the basis of two images (stereo images) of the sky captured by the stereo camera 30 at the same time, and generates a weather report, such as METAR, containing the cloud height.

The stereo camera 30 includes two cameras disposed with a predetermined baseline length left between each other to capture two images having disparity between each other (stereo images). For example, the stereo camera 30 has a camera platform portion capable of panning and tilting, and a zoom lens capable of optical zooming. The stereo camera 30 may include either visible light cameras or near infrared cameras. When near infrared cameras are used, images of the sky can be captured even during nighttime. When visible light cameras are used, high-resolution color images or intensity images can be captured. The stereo camera 30 adds an imaging time to captured stereo images of the sky as attribute information, and transmits these stereo images to the cloud height measuring device 20 via the network 50. The stereo images thus formed are used for calculation of a distance to an object, i.e., a cloud, based on disparity, at the time of estimation of a lifting condensation level. As a different configuration, three or more cameras may be dispersedly arranged, and two of these cameras may be combined in appropriate manners to constitute the stereo camera 30. In this case, a plurality of stereo images having different baseline lengths can be obtained.

The visible light camera 31 captures an image in the same imaging range as that of the stereo camera 30, adds an imaging time to the captured visible light image as attribute information, and transmits the visible light image to the cloud height measuring device 20 via the network 50. When the stereo camera 30 includes visible light cameras, the visible light camera 31 may be eliminated. In this case, one of stereo images may be used as a visible light image.

The ceilometer 32 measures a height of a cloud (lifting condensation level) existing immediately above, adds a measuring time to the height as attribute information, and transmits the height to the cloud height measuring device 20 via the network 50. When a multilayered cloud exists immediately above, the ceilometer 32 can measure lifting condensation levels of the respective layers.

For example, the external device 40 includes an anemometer, a visibility measuring device, and a weather satellite, and outputs wind direction and wind velocity information, and visibility information.

The cloud height measuring device 20 includes a correction processing section 201, a stereo vision distance measuring section 202, a lifting condensation level estimation section 203, an image reception section 204, a communication section 205, an object recognition section 207, a cloud shape recognition section 208, a direction difference detection section 209, a camera control section 210, a weather information retention section 211, and a correction information retention section 212.

The stereo vision distance measuring section 202 detects disparity of stereo images by block matching, feature matching, or other methods to calculate a distance to a cloud.

The lifting condensation level estimation section 203 calculates a cloud height on the basis of a distance to a cloud obtained by the stereo vision distance measuring section 202. The calculated cloud height is corrected on the basis of a lifting condensation level immediately above the ceilometer 32, which is measured by the ceilometer 32. The lifting condensation level estimation section 203 also acquires information, such as a wind direction, a wind velocity, and a visibility, provided by the external device 40 via the network 50, and stores the information in the weather information retention section 211. The lifting condensation level estimation section 203 further generates a weather report, such as METAR, on the basis of a corrected cloud height, and a wind direction, a wind velocity, a visibility, and the like acquired from the external device 40. Note that the weather report to be generated may be an aviation selected special weather report (SPECI), a terminal aerodrome forecast report (TAF), a trend forecast report (TREND), a voice language meteorological report (VOLMET), or a SCAN report (SCAN), instead of METAR.

The image reception section 204 acquires stereo images and a visible light image from the stereo camera 30 and the visible light camera 31, respectively, via the communication section 205, and stores these acquired images in the weather information retention section 211.

The communication section 205 is connected with the stereo camera 30 and the visible light camera 31 via the network 50 to transmit control information associated with control of the cameras 30 and 31, and receive image information from the cameras 30 and 31. Moreover, the communication section 205 communicates with the ceilometer 32 and the external device 40 via the network 50, and receives information provided by the devices 40 and 50.

The object recognition section 207 performs a feature point matching process for matching between an object in a received image and imaging data of a reference object retained in an object information retention section 213 to acquire a displacement amount of the object in the image for each pixel when the image contains the reference object.

The cloud shape recognition section 208 performs a cloud shape recognition process to identify a high cloud contained in stereo images, and executes a feature point matching process for an area including this high cloud to acquire coordinates of matching.

According to the present embodiment, a correction amount is acquired on the basis of feature point coordinates obtained by the matching process performed by either the object recognition section 207 or the cloud shape recognition section 208. Accordingly, the respective units 207 and 208 can be collectively considered as a matching coordinate acquisition section.

The direction difference detection section 209 performs a direction difference detection process to acquire a displacement amount of a fixed object, a celestial body, or a high cloud. When this value is different from a value indicated by a correction table retained in the correction information retention section 212, the direction difference detection section 209 updates the value of the correction table to the acquired value, and updates the correction table retained in the correction information retention section 212 and an image used for calculation of the displacement amount. When the displacement amount of the fixed object, the celestial body, or the high cloud is larger than a threshold specified beforehand, the direction difference detection section 209 updates pan and tilt angles of an imaging order table retained in the correction information retention section 212 to pan and tilt angles reflecting a correction amount calculated from the displacement amount, saves the updated imaging order table in the correction information retention section 212, and outputs “correction required” as a correction necessity result.

The camera control section 210 cyclically gives instructions on pan and tilt angles and a zoom magnification to the stereo camera 30 via the communication section 205 in accordance with information indicated by the imaging order table to cause the stereo camera 30 to perform imaging. The camera control section 210 also causes the stereo camera 30 to perform imaging in a similar manner when the direction difference detection section 209 outputs “correction required.”

The weather information retention section 211 retains stereo images and a visible light image received by the image reception section 204, information acquired by the lifting condensation level estimation section 203 from the external device 40, a cloud height estimation result obtained by the lifting condensation level estimation section 203, and a generated weather report.

The correction information retention section 212 retains an imaging order table indicating an imaging order, a correction table indicating correction information, and an image used at the time of update of the correction table. The object information retention section 213 retains information associated with a fixed object or a celestial body used for update of the correction table.

A UI section 214 is an interface section which presents various information to a user, and receives various operations from the user.

An internal clock 215 is connected to a not-illustrated network time protocol (NTP) server via the communication section 205 and the network 50, corrects time information retained by the internal clock 215, and supplies the corrected time information to respective sections of the cloud height measuring device 20, the stereo camera 30, the visible light camera 31, the ceilometer 32, and the like. Note that correction of the time information may be executed by using a satellite positioning system such as a global positioning system (GPS), instead of using the NTP server.

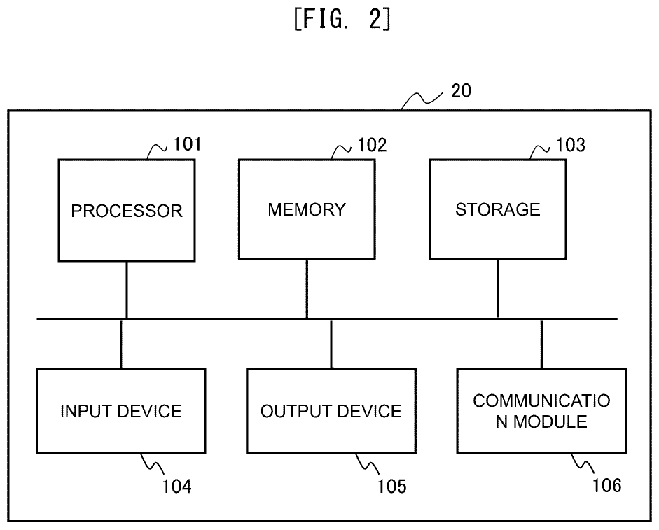

FIG. 2 is a block diagram illustrating a simplified configuration of the cloud height measuring device 20.

The cloud height measuring device 20 includes a processor 101, a memory 102, a storage 103, an input device 104, an output device 105, and a communication module 106.

For example, the processor 101 includes a central processing unit (CPU) and/or a graphics processing unit (GPU), or other types of arithmetic device. The functions of the respective above-mentioned sections included in the cloud height measuring device 20 are implemented under a program retained in the memory 102 and executed by the processor 101 with use of the storage resources (memory 102 and storage 103), the communication module 106, and the like.

The memory 102 includes a storage element such as a dynamic random access memory (DRAM), and is used to retain the program for implementing the respective functions of the cloud height measuring device 20, and various data used by the processor 101 for executing the program.

The storage 103 is a non-volatile storage device such as a hard disk drive (HDD) and a solid state drive (SSD), and functions as the weather information retention section 211, the correction information retention section 212, and the object information retention section 213.

The input device 104 is a device through which information and various operations are input from the user, such as a keyboard, a mouse, and a touch panel. The output device 105 is a device for presenting various information to the user, such as a display and a printer. Each of the input device 104 and the output device 105 functions as the UI section 214.

The communication module 106 is an interface for communicating via the network 50 with respective devices, such as a network interface card (NIC), connected to the network 50. The communication module 106 functions as the communication section 205.

The cloud height measuring device 20 may be constituted by an ordinary computer such as a personal computer and a server computer, or may be constituted by a dedicated device, or a system including a plurality of computers or devices. Moreover, for implementing a part or all of the functions of the respective sections described above, the cloud height measuring device 20 may include a dedicated circuit such as a field programmable gate array (FPGA), an application specific integrated circuit (ASIC), and a complex programmable logic device (CPLD).

The program may be installed into the storage 103 from a program source, and read into the memory 102 when executed by the processor 101. For example, the program source may be a storage medium readable by a program distribution server or the cloud height measuring device 20. When the program source is a program distribution server, this program distribution server may include a processor and a storage resource for storing a program to be distributed. In this case, the processor of the program distribution server may distribute the program to be distributed to a different computer. Moreover, according to the present embodiment, all of the functions of the respective sections described above may be implemented as one program, or each of the functions of the respective units may be implemented as one or more programs.

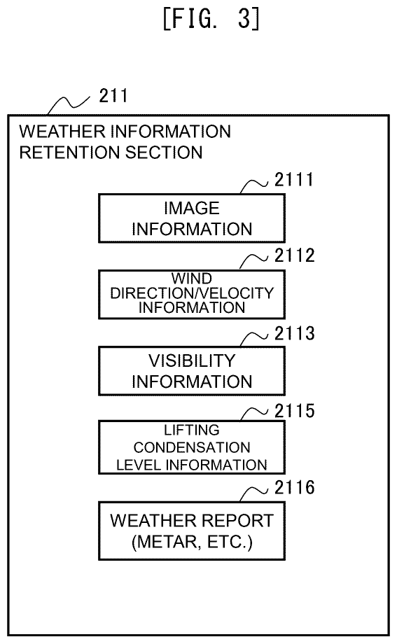

FIG. 3 is a conceptual diagram illustrating weather information stored in the weather information retention section 211.

Image information 2111 includes stereo images having disparity between each other and captured by the stereo camera 30 at the same time, and a visible light image captured by the visible light camera 31 at the same time as the imaging time of the stereo camera 30. Wind direction/velocity information 2112 is information acquired from the external device 40 and indicating a wind direction and a wind velocity at a measuring spot. Visibility information 2113 is information acquired from the external device 40 and indicating a visibility at a measuring spot. Lifting condensation level information 2115 is information indicating a lifting condensation level (a minimum altitude of a cloud) immediately above the ceilometer 32, which is measured by the ceilometer 32. A weather report 2116 is METAR generated by the lifting condensation level estimation section 203.

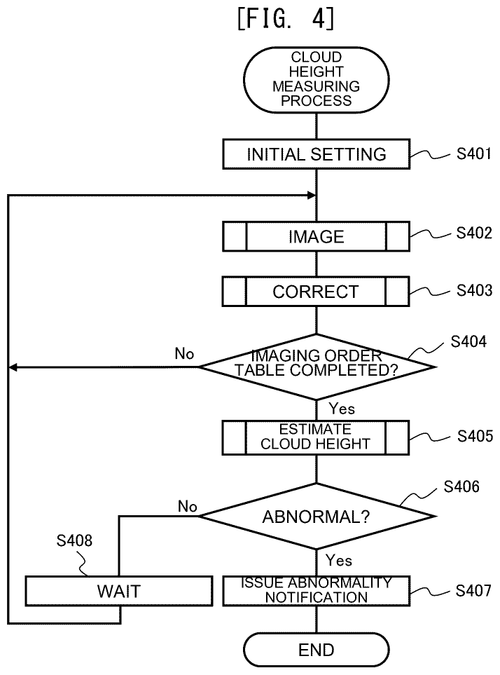

FIG. 4 is a flowchart illustrating an example of a cloud height measuring process according to the present embodiment. Note that the cloud height measuring process is performed on an assumption that the wind direction/velocity information 2112, the visibility information 2113, cloud top altitude information 224, and the lifting condensation level information 2115 have been regularly acquired by the lifting condensation level estimation section 203 from the ceilometer 32 and the external device 40, and stored in the weather information retention section 211. In addition, respective following processes including the present process are specifically achieved under the program retained in the memory 102 and executed by the processor 101.

For example, the cloud height measuring process is started in response to a predetermined start operation input from the user. When the process is started, the cloud height measuring device 20 causes the camera control section 210 to input initial settings of the stereo camera 30 and the visible light camera 31 via the network 50. For inputting the initial settings, the camera control section 210 transmits time information indicated by the internal clock 215 to the stereo camera 30 and the visible light camera 31 to synchronize imaging time added to captured images with the time information indicated by the internal clock 215. Moreover, the camera control section 210 executes calibration between two cameras constituting the stereo camera 30. Furthermore, for preparing for imaging carried out later, an imaging order table is read from the correction information retention section 212 (step S401).

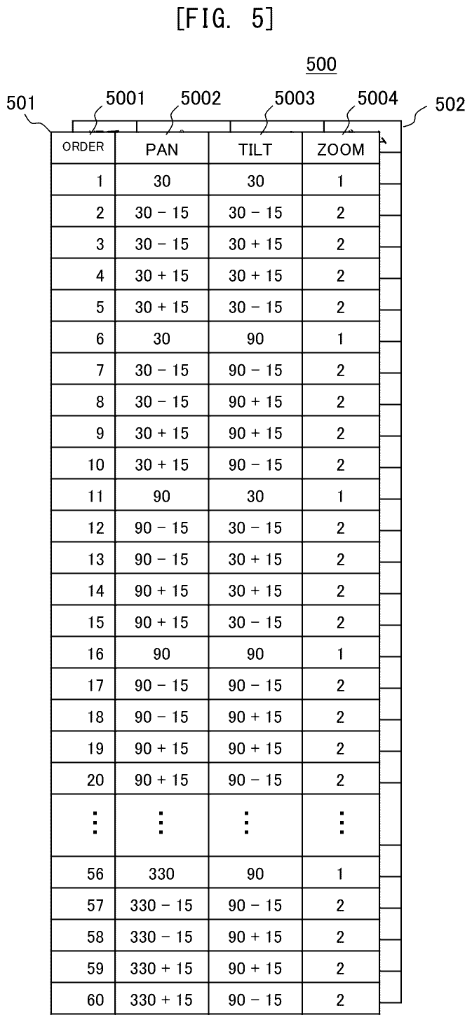

FIG. 5 is a data configuration diagram illustrating an example of a configuration of the imaging order table. While data having a table structure is adopted in the present embodiment, information indicating the imaging order may be retained in other data formats, such as a list structure. This point is also applicable to correction tables described below.

An imaging order table 500 includes a first table 501 used for controlling one of the cameras constituting the stereo camera 30, and a second table 502 used for controlling the other camera. According to the present embodiment, imaging is carried out a plurality of times while changing a combination of a pan angle, a tilt angle, and a zoom magnification. The imaging order is registered in a corresponding table of the imaging order table 500 for each of the combinations of the pan angle, the tilt angle, and the zoom magnification of the imaging performed by each of the cameras constituting the stereo camera 30.

An “order” column 5001 indicates a serial number indicating an order of execution of imaging in an ascending order. A “pan” column 5002 indicates information associated with a pan angle corresponding to a rotation angle around a vertical axis representing a direction of a camera platform of the stereo camera 30, and is set in an angle range from “0” to “359” degrees. The direction at the pan angle of 0 degrees is set to the same direction for the plurality of cameras constituting the stereo camera 30. For example, this direction may be set with reference to a direction of an axis perpendicular to a baseline in the horizontal direction, an azimuth angle, or the like. Moreover, a negative value or a value of 360 degrees or more is converted into a value falling within the range from 0 to 359 by addition or subtraction of 360. A “tilt” column 5003 indicates information associated with a tilt angle corresponding to an angle of the camera platform of the stereo camera 30 in an elevation angle direction, and a zenith angle is written in a range from “0” degrees to “90” degrees. The zenith angle of 90 degrees is such a state where the optical axis of the camera, i.e., the axis perpendicular to a sensor surface, is perpendicular to the vertical axis, while the zenith angle of 0 degrees is such a state where the camera is directed in parallel to the vertical axis and faces right above. According to the present embodiment, each of the pan angle and the tilt angle is assumed to have an axis extending in a direction common to the plurality of cameras constituting the stereo camera 30. In addition, information set for the imaging order table is used as information common to the plurality of cameras. A “zoom” column 5004 is a column for which a zoom magnification of the stereo camera 30 is set. In this column, “1” indicates imaging at a single zoom magnification, i.e., a reference magnification on the wide angle side, while “2” indicates imaging at a double zoom magnification twice larger than the single magnification.

According to the present embodiment, it is assumed that each of the cameras constituting the stereo camera 30 is capable of optical zooming, and has a viewing angle of 60 degrees in the horizontal direction (pan direction) and the vertical direction (tilt direction) at the single zoom magnification, and has a viewing angle of 30 degrees in these directions at the double zoom magnification. For imaging covering the whole sky without a break by using the camera configured as above, each of the reference pan angle and the reference tilt angle is varied by 60 degrees for each imaging in the present embodiment. Specifically, after one viewing angle is imaged once at the single zoom magnification, the zoom magnification is doubled and the same visual field is divided into four parts to be imaged four times for the divided parts. In this manner, imaging is carried out five (1+4) times as one set.

For imaging the whole sky, imaging in six directions, which is calculated by dividing 360 degrees by 60 degrees, is required for the pan direction, and imaging in two directions, which is calculated by dividing 90 degrees by 60 degrees, is required for the tilt direction at the single zoom magnification. Accordingly, for imaging the whole sky, imaging in 12 (6×2) directions is required by combining the foregoing directions. When an entire visual field imaged at the reference magnification is to be imaged at the double zoom magnification, imaging four times for each of directions (visual fields) is required as described above. Accordingly, imaging in 12×4 =48 directions is required. However, this imaging includes imaging in directions at zenith angles exceeding 90 degrees at which no cloud is imaged at the double zoom magnification. Specifically, imaging in these directions results from a combination providing the zoom magnification of “2,” and the tilt angle of “90+15” degrees as the combination of the pan angle, the tilt angle, and the zoom magnification. The imaging order table 500 includes 12 combinations corresponding to this type of combination. When imaging in these combinations is skipped or excluded from the imaging order table 500, the whole sky can be covered by imaging only 48 (60-12) times at each of the single and double zoom magnifications. This manner of imaging can reduce a processing time, and is effective in view of saving of the storage capacity.

The zoom magnification is set to the single and double magnifications herein for simplifying the explanation. However, for imaging at single and tenfold magnifications by using a camera capable of tenfold optical zooming at the same viewing angle, for example, imaging 12 times at the single zoom magnification similarly to above, and imaging 900 times at the tenfold magnification, i.e., imaging 912 times in total is required for covering the whole sky. Note that overlap between viewing angles increases as the direction of the camera approaches the zenith. Accordingly, reduction of the number of times of imaging, and reduction of the time required for imaging and the cloud height estimation process can be achieved by imaging at a pan angle and a tilt angle for minimizing this overlap.

Returning to FIG. 4, the cloud height measuring device 20 having completed input of the initial settings causes the camera control section 210 to image the whole sky by controlling the stereo camera 30 and the visible light camera 31 in accordance with the imaging order table 500. The cloud height measuring device 20 acquires the stereo images and the visible light image obtained by imaging from the image reception section 204, and stores these images in the weather information retention section 211 as the image information 2111. Moreover, the stereo images obtained by imaging are sequentially passed to the object recognition section 207, the cloud shape recognition section 208, and the direction difference detection unit 209, and the correction table stored in the correction information retention section 212 is updated according to the stereo images transmitted. Thereafter, the images used for the correction are stored (step S402).

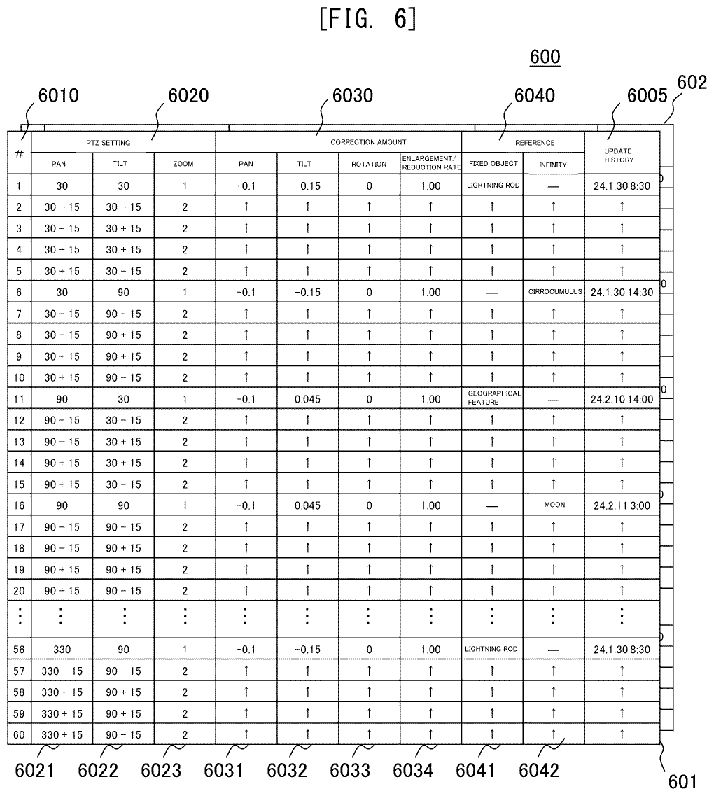

FIG. 6 is a data configuration diagram illustrating an example of a configuration of the correction table.

The correction table 600 includes a first table 601 corresponding to one of the two cameras constituting the stereo camera 30, and a second table 602 corresponding to the other camera, each formed in a manner similar to the manner of the imaging order table 500.

A “#” column 6010 indicates a serial number indicating an order of imaging in an ascending order. A “PTZ setting” column 6020 includes a “pan” column 6021, a “tilt” column 6022, and a “zoom” column 6023 as columns corresponding to the “pan” column 5002, the “tilt” column 5003, and the “zoom” column 5004 of the imaging order table 500. A pan angle, a tilt angle, and a zoom magnification are set for the columns 6021, 6022, and 6023, respectively.

A “correction amount” column 6030 includes a “pan” column 6031, a “tilt” column 6032, a “rotation” column 6033, and a “enlargement/reduction rate” column 6034. A correction amount of an image captured according to a combination of the pan angle, the tilt angle, and the zoom magnification set for the corresponding “PTZ setting” column 6020 is set for the “correction amount” column 6030. A correction angle in an X-axis direction and a correction angle in a Y-axis direction each specified in the image are set for the “pan” column 6031 and the “tilt” column 6032, respectively, in the “correction amount” column 6030. Similarly, a correction amount indicating a correction angle in a rotation direction around an axis aligned with an image center is set for the “rotation” column 6033. Moreover, for example, an enlargement/reduction rate corresponding to a deviation amount of the zoom magnification according to aging of the zoom function of the stereo camera 30 is set for the “enlargement/reduction” column 6034.

A reference fixed object used for calculation of the correction amount set for the “correction angle” column 6030 is registered in a “fixed object” column 6041 of a “reference” column 6040, while a celestial body or a high cloud is similarly registered in an “infinity” column 6042. Furthermore, a date and a time at which information associated with the corresponding row is updated are registered in a “update history” column 6005.

Note that each of up-arrows in the table in FIG. 6 indicates the same value as above.

Returning again to FIG. 4, the cloud height measuring device 20 causes the correction processing section 201 to read the correction table 600 from the correction information retention section 212 and stereo images from the weather information retention section 211, and performs a correction process in accordance with the correction table 600. After completion of the correction process, the stereo images are stored in the weather information retention section 211, and also transferred to the stereo vision distance measuring section 202 (step S403).

The cloud height measuring device 20 determines whether imaging has been completed in all of the orders set for the imaging order table 500. If any order not completed yet remains in the imaging order table 500, the cloud height measuring device 20 executes the subsequent order of imaging (step S404).

After the foregoing processing is completed for all of the orders set for the imaging order table 500, the cloud height measuring device 20 performs a cloud height estimation process described below by using the stereo images captured in step S402 and stored in the weather information retention section 211, or the stereo images corrected in step S403 if any, to generate the weather report 116 (step S405).

The cloud height measuring device 20 determines whether an unrecoverable abnormality has been caused in the processing up to step S404, which may cause such a problem that estimation of the cloud height is impracticable in step S405, or that estimation of the cloud height is not completed within a predetermined time (step S406). If any abnormality is present, there is a possibility that a problem such as deviation of the imaging directions of the two cameras constituting the stereo camera 30 has been caused. Accordingly, the cloud height measuring device 20 causes the UI section 214 to issue a notification indicating this abnormality, and ends the cloud height measuring process (step S407). If the foregoing abnormality is absent, the cloud height measuring device 20 waits for next imaging timing, and returns to the imaging process in step S402 at the time of the next imaging timing to repeat the foregoing processing in a predetermined cycle, such as a cycle of 10 minutes (step S408).

The weather report 2116 generated by the foregoing processing and stored in the weather information retention section is provided to an airport or the like as necessary.

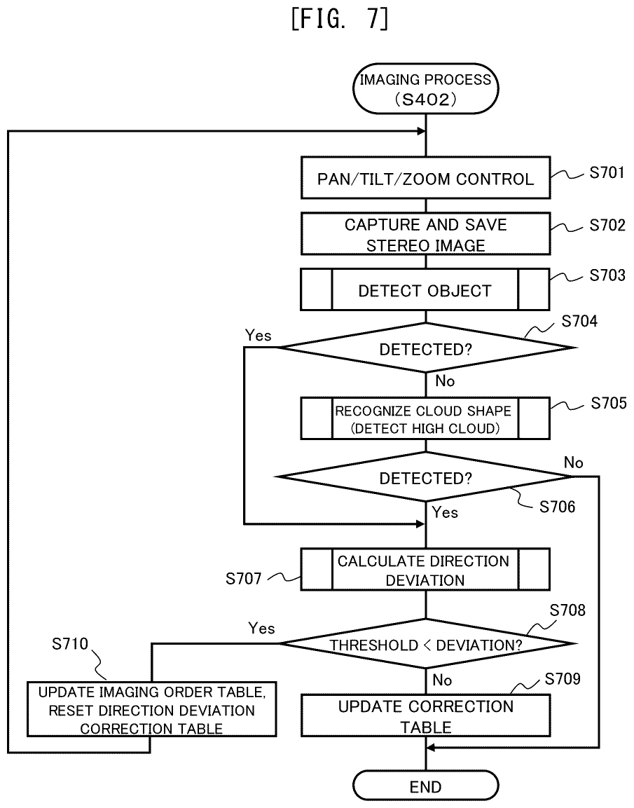

FIG. 7 is a flowchart illustrating a flow of the imaging process in step S402.

The camera control section 210 controls the direction and the zoom magnification of the stereo camera 30 in accordance with information set for the “pan” column 5002, the “tilt” column 5003, and the “zoom” column 5004 included in the imaging order table 500 (step S701). When the direction and the zoom magnification of the stereo camera 30 are set, the camera control section 210 releases a shutter of the stereo camera 30 to capture stereo images. The captured stereo images are acquired by the image reception section 204 and the communication section 205 via the network 50, and stored in the weather information retention section 211 (step S702).

The cloud height measuring device 20 causes the object recognition section 207 to read the stereo images stored in the weather information retention section 211, and performs an object detection process described below to acquire coordinates of a feature point of a fixed object or a celestial body in the images (step S703). The cloud height measuring device 20 determines whether or not the stereo images contain a fixed object or a celestial body, i.e., whether or not either a fixed object or a celestial body has been detected in step S703, and whether or not coordinates of a feature point have been acquired (step S704). If neither a fixed object nor a celestial body has been detected in step S703, the cloud height measuring device 20 causes the cloud shape recognition section 208 to perform a cloud shape recognition process described below to detect a high cloud, and acquires coordinates of a feature point of the high cloud (step S705). Thereafter, the cloud height measuring device 20 determines whether or not a high cloud has been detected in step S705. If no high cloud is detected, the cloud height measuring device 20 ends the imaging process in this imaging order (step S706).

If the presence of a fixed object or a celestial body has been confirmed in step S704, or if the presence of a high cloud has been confirmed in step S706, the cloud height measuring device 20 causes the direction difference detection section 209 to perform a direction deviation calculation process described below to obtain a displacement amount on the basis of acquired feature point coordinates of the acquired fixed object, celestial body, or high cloud. The displacement amount obtained herein includes a translation amount corresponding to a deviation amount in each of the pan and tilt directions, a rotation amount corresponding a deviation amount in the rotation direction around the axis aligned with the image center, and a displacement amount corresponding to an enlargement/reduction rate or the like of the image according to a change in the zoom magnification or the like (step S707).

The direction difference detection section 209 compares the translation amount included in the obtained displacement amount with a predetermined threshold. If the translation amount is smaller than or equal to the threshold determined beforehand, the direction difference detection section 209 sets a correction amount for a value in the corresponding column within the “correction amount” column 6030 of the correction table 600 on the basis of the obtained displacement amount (step S709). Meanwhile, if the translation amount exceeds the threshold, the direction difference detection section 209 corrects the values of the “pan” column 5002 and the “tilt” column 5003 of the imaging order table 500, and the “pan” column 6021 and the “tilt” column 6021 within the “PTZ setting” column 6020 of the correction table 600 by adding or subtracting the obtained translation amount. When the displacement amount contains displacements of the rotation and the enlargement/reduction rate, the direction difference detection section 209 sets correction amounts of the displacements for the “rotation” column 6033 and the “enlargement/reduction rate” column 6034 of the “correction amount” column 6030, and resets each of the values of the “pan” column 6031 and the “tilt” column 6032 within the “correction amount” column 6030 to zero to update these values. Thereafter, the cloud height measuring device 20 returns to the processing in step S701 to cause the camera control section 210 to again perform imaging by using new pan and tilt angles (step S710).

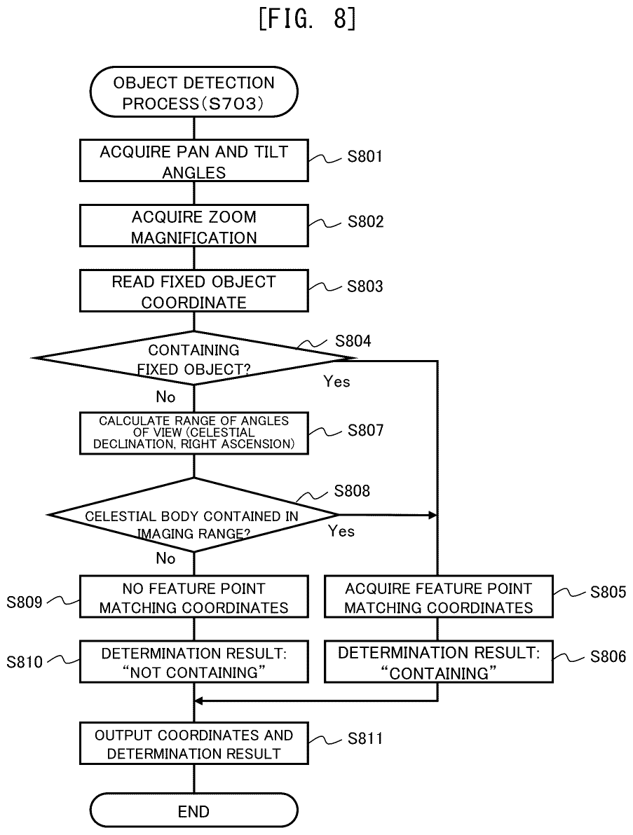

FIG. 8 is a flowchart illustrating a flow of the object detection process in step S703.

In the object detection process, the object recognition section 207 acquires the pan angle, the tilt angle, and the zoom magnification set by the pan-tilt-zoom control in step S701 from the information added to the images read from the weather information retention section 211 (steps S801 and S802). Moreover, the object recognition section 207 reads a fixed object table which retains information associated with a reference fixed object from the object information retention section 213 (step S803).

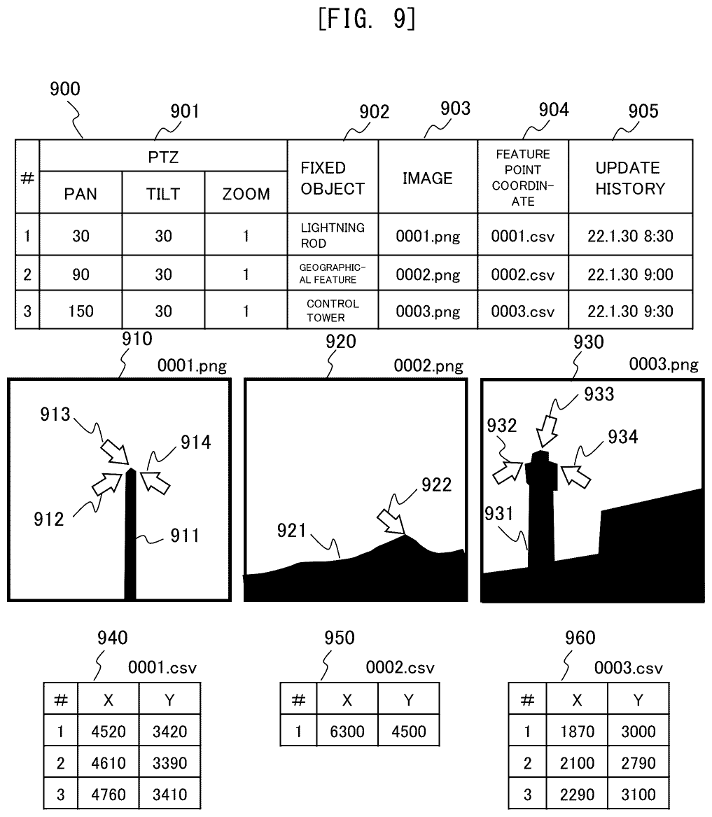

FIG. 9 is a schematic diagram for explaining an example of the fixed object table. Note that the fixed object table is also provided for each of the cameras constituting the stereo camera 30 in a manner similar to the manners of the imaging order table 500 and the correction table 600. FIG. 9 illustrates one of these fixed object tables.

Information associated with a reference fixed object is registered in each of rows of the fixed object table 900. A pan angle and a tilt angle indicating directions of the cameras at the time of imaging of the fixed object, and a zoom magnification used for the imaging are retained in a “PTZ” column 901 of the fixed object table 900. A type of the imaged fixed object is registered in a “fixed object” column 902. A path indicating a location where an image file of the imaged fixed object is saved is registered in an “image” column 903. The image file identified by this path is used for feature point matching with the stereo images. A file in a png format is used herein as an example of the image file. Registered in a “feature point coordinate” column 904 is a path of a file where coordinates of a feature point of the fixed object contained in the image file identified by the “image” column 903 are recorded. The coordinates of the feature point registered in the file identified by this path are used as reference coordinates at the time of acquisition of a displacement amount of the feature point. A csv format file is used herein as an example of the file where the feature point coordinates are recorded. A date and a time of registration of information in the corresponding row are set for an “update history” column 905.

Each of images 910, 920, and 930 indicates an image recorded in an image file identified in a corresponding row of the “image” column 903. Moreover, each of tables 940, 950, and 960 is a table indicating, in a tabular form, feature point information recorded in a csv file identified in a corresponding row of the “feature point coordinate” column 904.

The image 910 contains an image of a lightning rod 911 corresponding to a fixed object. Three feature points of the image 910 are indicated by arrows 912, 913, and 914. Coordinates of each of the three feature points are expressed in X-Y coordinates in the image, and recorded in an “X” column and a “Y” column of a corresponding row in the table 940. The image 920 contains an image of a geographical feature (mountain) 921 corresponding to a fixed object. Values of an X-coordinate and a Y-coordinate of one feature point 922 are recorded in the csv file as information associated with the X-coordinate and the Y-coordinate as indicated in the table 950. In addition, the image 930 contains an image of an airport control tower 931 corresponding to a fixed object. X-coordinates and Y-coordinates of three feature points are similarly recorded in the csv file as indicated in respective rows of the table 960. These files are stored in the object information retention section 213 together with the fixed object table 900.

For increasing accuracy of the translation amount, the rotation angle, and the enlargement/reduction rate acquired by direction deviation calculation described below or by other methods, it is preferable that a plurality feature points are acquired for one combination of panning, tilting, and zooming.

Note that the object information retention section 213 retains information for identifying a celestial body having a reference brightness magnitude, as well as the information associated with the fixed objects as described above. In addition, the position of the celestial body is changeable for each date and time. For handling this positional change, a table similar to the fixed object table 900 may be prepared for each time zone, or information associated with celestial bodies to be used may be changed for each season, for example. Coordinates of the celestial bodies for which information is to be retained in this case may be acquired on the basis of information provided by an external database, or by astronomical calculation, for example.

Returning to FIG. 8, the object recognition section 207 determines whether a reference fixed object corresponding to the pan angle, the tilt angle, and the zoom magnification acquired in steps S801 and S802 has been registered in the fixed object table 900, with reference to the “PTZ” column 901 of the fixed object table 900 (step S804). If registration of this fixed object is confirmed, the object recognition section 207 carries out feature point matching between stereo images read from the weather information retention section 211 and image information retained in the object information retention section 213.

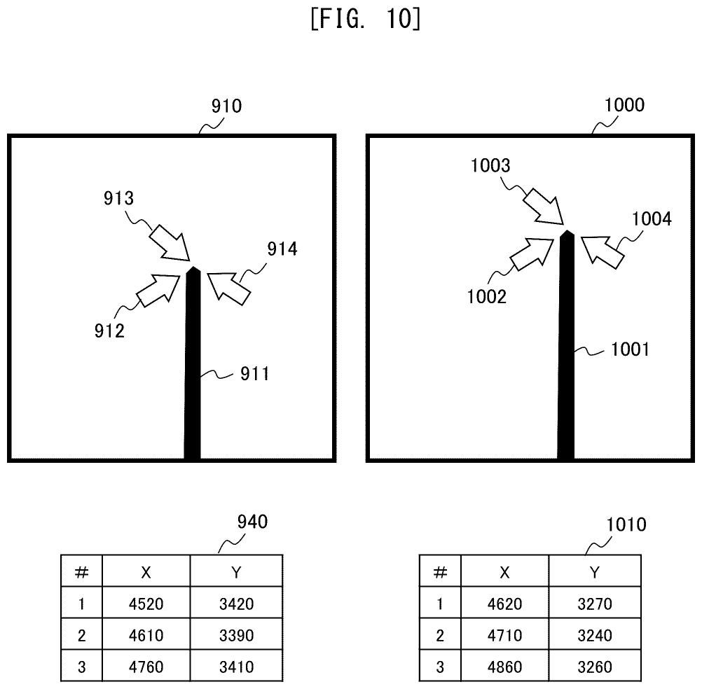

FIG. 10 is a schematic diagram for explaining an outline of the matching process. The image 910 and the table 940 represent the image of the lightning rod 911 as a reference fixed object and the table indicating details of the file where the feature points of this image are recorded, respectively, both registered in the first row of the fixed object table explained with reference to FIG. 9. An image 1000 is a stereo image (one of two images constituting stereo images) containing a lightning rod 1001 and read from the weather information retention section 211. Arrows 1002, 1003, and 1004 are feature points detected by feature point matching and corresponding to the feature points indicated by the arrows 912, 913, and 914 in the image 910, respectively. A table 1010 indicates information associated with >coordinates and Y-coordinates of the feature points indicated by the arrows 1002, 1003, and 1004. As can be seen from a difference obtained by comparison between the coordinates registered in the table 940 and the coordinates in the table 1010, the feature points in the image 1000, i.e., the stereo image read from the weather information retention section 211, are translated from the feature points of the image 910, i.e., the image retained in the object information retention section 213, in the X-axis positive direction by 100 pixels, and in the Y-axis negative direction by 150 pixels. The object recognition section 207 acquires sets of coordinates of the feature points obtained by the matching process, and corresponding coordinates in a file indicated by the “feature point coordinate” column 904 of the fixed object table 900, as feature point matching coordinates (step S805). Thereafter, the object recognition section 207 obtains a result of “containing a fixed object” as a determination result (step S806).

Meanwhile, if it is determined that the stereo image contains no registered fixed object in step S804, a range of angles of view contained in the stereo image is calculated by using celestial declination and right ascension (step S807). Subsequently, the object recognition section 207 examines whether or not a celestial body having a reference brightness magnitude is present in the calculated range of celestial declination and right ascension in a time zone indicated by a time stamp added to the stereo image or a reception time of the stereo image (step S808). If such a celestial body is present, the object recognition section 207 acquires information associated with this celestial body and advances the flow to step S805, and then carries out feature point matching similar to the feature point matching applied to the case of the fixed object to acquire matching coordinates as a combination of coordinates of a position where this celestial body is originally located, and coordinates of a position (feature point) of the celestial body contained in the image. In this case, a determination result of “containing a celestial body” is obtained in step S806.

If it is determined that no appropriate celestial body is present in step S808, the object recognition section 207 determines absence of feature point matching coordinates (step S809), and obtains a determination result of “not containing a celestial body” (step S810).

Finally, the object recognition section 207 outputs the determination result obtained by the foregoing processing and indicating whether or not a fixed object or a celestial body is contained, and feature point matching coordinates if receiving a determination result indicating that a fixed object or a celestial body is contained (step S811).

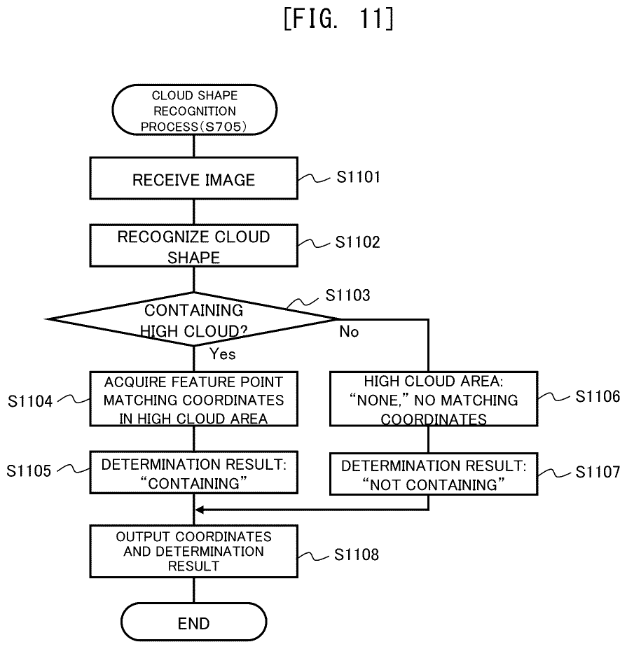

FIG. 11 is a flowchart illustrating a flow of the cloud shape recognition process in step S705.

If it is determined that the stereo images contain no reference fixed object or celestial body in step S704, the cloud shape recognition section 208 receives the stereo images from the object recognition section 207 (step S1101), and executes cloud shape recognition for the received stereo image. For example, for this cloud shape recognition, an image recognition process using a learning model for which machine learning has been completed beforehand may be applied (step S1102).

The cloud shape recognition section 208 determines whether or not a high cloud (stratus, cirrostratus, cirrocumulus) is contained on the basis of a result of the cloud shape recognition (step S1103). If it is determined that a high cloud is contained, the cloud shape recognition section 208 executes feature point matching between two images constituting the stereo images on the basis of a reference image captured by one of the cameras constituting the stereo camera 30 in a segmentation area in the image containing the high cloud. Feature point matching coordinates obtained herein are acquired as a matching image for the image captured by the other camera (step S1104). Thereafter, the cloud shape recognition section 208 obtains a result of determination of “containing a high cloud” (step S1105).

If it is determined that no high cloud is contained in step S1103, the cloud shape recognition section 208 determines feature point matching coordinates are absent (step S1106), and obtains a determination result of “not containing a high cloud” (step S1107). If the determination result indicating presence or absence of the feature point matching coordinates, and the matching coordinates are obtained, the cloud shape recognition section 208 finally outputs these coordinates (sets of the coordinates of the matched feature points between the two images), and ends the process (step S1108).

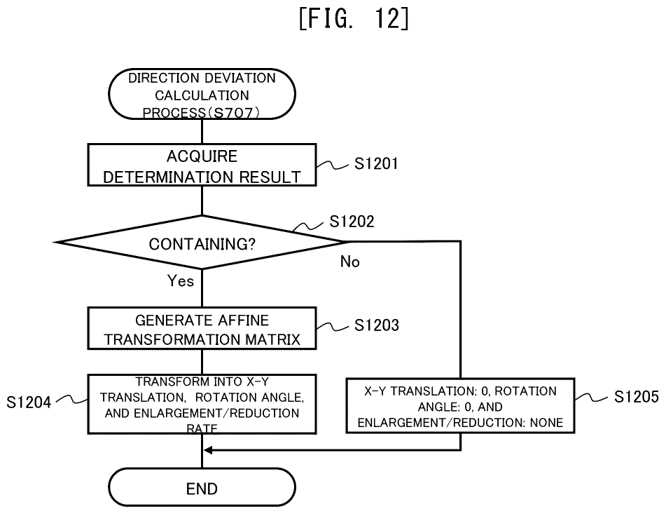

FIG. 12 is a flowchart illustrating a flow of the direction deviation calculation process in step S707. The direction difference detection section 209 receives a determination result indicating whether or not a fixed object, a celestial body, or a high cloud is contained from the object recognition section 207 or the cloud shape recognition section 208 (step S1201). The direction difference detection section 209 determines whether or not the received determination result indicates that a fixed object, a celestial body, or a high cloud is contained (step S1202). If the determination result is affirmative, the direction difference detection section 209 calculates a translation amount, a rotation amount, and an enlargement/reduction rate for minimizing the distances between the coordinates of the matched feature points by using an interactive closest point (ICP) method or a least squares method, for example, on the basis of the feature point matching coordinates received together with the determination result. Thereafter, an affine transformation matrix expressing the translation amount, the rotation amount, and the enlargement/reduction rate thus obtained is generated (step S1203) to execute transformation into X-Y translation, a rotation angle, and an enlargement/reduction rate used in step S709 or S710 (step S1204).

Meanwhile, if it is recognized that the determination result in step S1202 indicates that no fixed object, celestial body, or high cloud is contained, the direction difference detection section 209 sets the X-Y translation, the rotation angle, and the enlargement/reduction rate to 0, 0 degrees, and 1 (no enlargement/reduction), respectively (step S1205).

In addition, if it is determined in S1202 that the received determination result indicates presence of a high cloud, processing in steps S1203 and 1204 is performed for the image captured by the other camera in the processing of step S705 described with reference to FIG. 11. In this case, the X-Y translation, the rotation angle, and the enlargement/reduction rate are set to 0, 0 degrees, and 1 (no enlargement/reduction), respectively, for the image captured by the one camera.

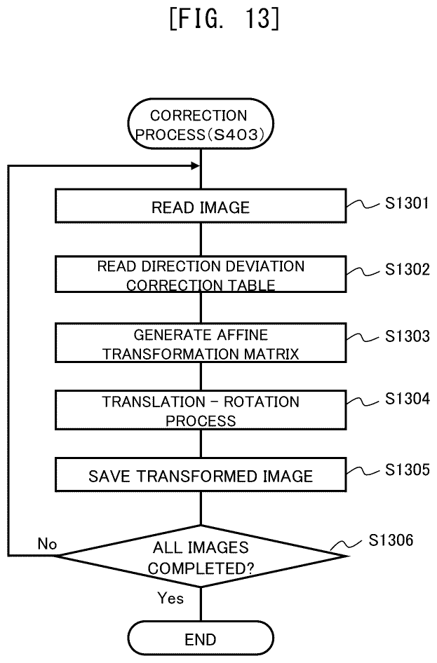

FIG. 13 is a flowchart illustrating a flow of the correction process in step S403.

The correction processing section 201 reads the stereo images stored in the weather information retention section 211 (step S1301), and acquires correction information included in the “correction amount” column 6030 corresponding to an imaging order of the stereo image and read from the correction table 600 of the correction information retention section 212 for each of two images constituting the stereo images (step S1302). The correction processing section 201 subsequently generates an affine transformation matrix for each of the images constituting the stereo images on the basis of the correction information acquired from the correction table 600 (step S1303). The correction processing section 201 transforms the respective images constituting the stereo images by using the generated affine transformation matrixes (step S1304), and saves the transformed images in the weather information retention section 211 (step S1305). Thereafter, the correction processing section 201 determines whether the processing has been completed for all of captured stereo images. If any unprocessed stereo image remains, the flow returns to step S1301 to repeat the correction process until completion of the process for all of the images (step S1306).

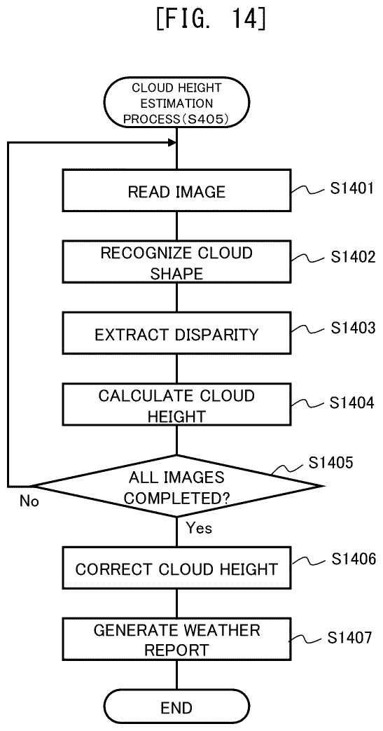

FIG. 14 is a flowchart illustrating a flow of the cloud height estimation process in step S405.

In the cloud height estimation process, the stereo vision distance measuring section 202 reads stereo images (corrected images if the correction process is carried out for the images in step S403) from the weather information retention section 211 (step S1401). The stereo vision distance measuring section 202 performs the cloud shape recognition process for the read stereo images to detect a cloud on the basis of semantic segmentation using ten types of cloud shapes. For example, the cloud shape recognition process can be achieved by applying an image recognition process using a learning model for which machine learning has been completed beforehand (step S1402). Thereafter, a disparity extraction process using a block matching method or a feature matching method is executed for each of detected cloud shape regions to extract disparity (step S1403), and a distance to the cloud is acquired on the basis of the extracted disparity (step S1404). The stereo vision distance measuring section 202 determines whether this process has been executed for all of the stereo images. If any unprocessed stereo image remains, the flow returns to the processing in step S1401 to perform the processing for the unprocessed stereo image (step S1405).

After completion of the processing for the stereo images by the stereo vision distance measuring section 202, the lifting condensation level estimation section 203 calculates a cloud height of the cloud on the basis of the acquired distance to the cloud and the direction of the stereo camera (tilt angle). The lifting condensation level estimation section 203 further reads the lifting condensation level information 2115 from the weather information retention section 211, and corrects a cloud height calculated on the basis of a cloud height provided by the ceilometer. For example, when a cloud height of a cloud A acquired by the cloud height measuring device 20 is different from a cloud height of the cloud A measured by the ceilometer, the lifting condensation level estimation section 203 makes a correction for equalizing the cloud height of the cloud A acquired by the cloud height measuring device 20 with the cloud height acquired by the ceilometer. The lifting condensation level estimation section 203 further corrects cloud heights of clouds other than the cloud A at the same correction rate as the rate of the correction for the cloud A (step S1406). The lifting condensation level estimation section 203 finally generates a weather report on the basis of the corrected cloud height, and information retained in the weather information retention section 211, such as the wind direction/velocity information 2112 and the visibility information 2113 (step S1407).

When no cloud is detected in the processing from steps S1402 to S1404, the processing from steps S1403 to S1406 is skipped. In this case, the weather report 2116 indicating absence of cloud is generated in step S1407.

In addition, if no disparity is extracted from the stereo images in step S1403 even in a state where a cloud shape has been recognized in step S1402, there is a possibility that deviation of the imaging directions of the two cameras constituting the stereo camera 30, or other problems have been caused. In this case, the UI section 214 notifies the user of the fact that an abnormality has been caused (step S408).

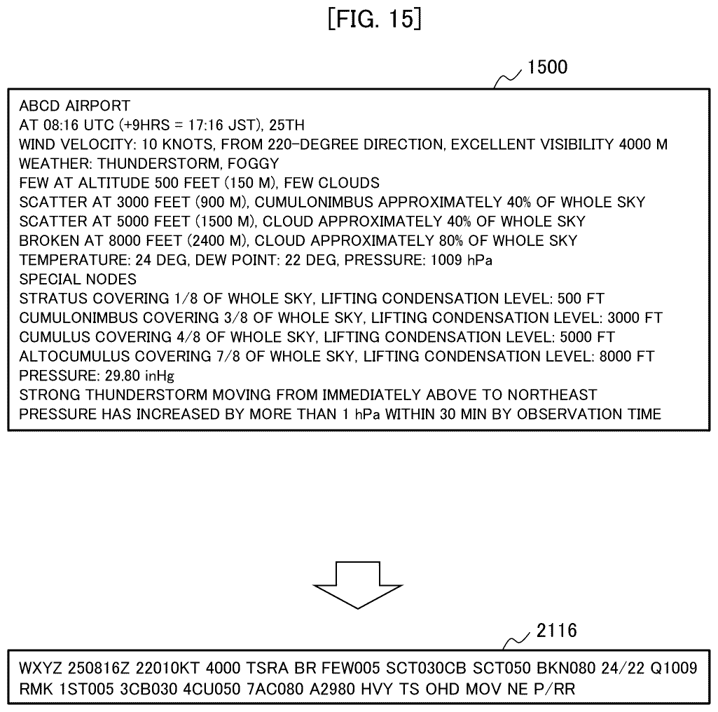

FIG. 15 is a conceptual diagram illustrating an example of METAR corresponding to a type of weather reports. As illustrated in the figure, a text volume can be considerably reduced without a decrease in the information volume by transforming information 1500 in respective items associated with weather, which is written in normal sentences, into the weather report 2116.

According to the embodiment described above, corrections are made in such a manner as to eliminate a displacement of feature point matching coordinates of a fixed object, a celestial body, and a high cloud. These corrections can correct collapse of stereo parallelization caused by aging of the plurality of cameras constituting the stereo camera, the camera platform determining directions of these cameras, and the like, and maintain highly accurate cloud height measurement. Moreover, these corrections are executable during both daytime and nighttime on the basis of corrections using a fixed object and a high cloud during daytime, and corrections using a fixed object such as an illuminated building and shade of a mountain, and a celestial body during nighttime.

According to the embodiment described above, the imaging order table, the correction table, the fixed object information table, and the like are provided for each of the plurality of cameras constituting the stereo camera. However, information provided for each of the plurality of cameras may be collected into one table.

Moreover, while correction amounts are acquired by feature point matching using coordinates of a known fixed object or a known celestial body for each of the cameras constituting the stereo camera, feature point matching may be executed by comparing images captured by the stereo camera with each other. In this case, the cloud height measuring device, in step S402, designates an image captured by one of the cameras constituting the stereo camera as a reference, and then acquires a displacement amount of a feature point in an image captured by the other camera on the basis of a displacement amount of disparity, and acquires a correction amount of an image captured by the other camera. Thereafter, the cloud height measuring device, in step S403, may form a corrected image of the image captured by the other camera by performing affine transformation using the acquired correction amount. In addition, when the translation amount exceeds the threshold, correction amounts of the pan angle and the tilt angle of the other camera may be retained as correction information instead of updating the imaging order table. Then, these correction amounts may be added to or subtracted from the pan angle and the tilt angle indicated by the imaging order table to control the direction of the one camera at the time of imaging.

The embodiment described above has been presented as a typical mode of the present invention. It is therefore not intended that the present invention be limited to this embodiment. Various modifications may be made without departing from the scope of the spirit and scope of the present invention. For example, the embodiment presented above has been described in detail for easy understanding of the present invention, and all of the configurations are not necessarily required to be equipped.

What is claimed is:

1. A cloud measuring system comprising:
a stereo camera that includes a plurality of cameras each capable of changing an angle in a pan direction and an angle in a tilt direction, and captures stereo images that include a plurality of images having disparity between each other;
a camera control section that controls the angle in the pan direction and the angle in the tilt direction for each of the plurality of cameras to control capture of the stereo images by the stereo camera;
a reception section that receives the stereo images from the stereo camera;
a matching coordinate acquisition section that acquires a feature point of an object contained in the stereo images, and acquires, as matching coordinates, a combination of reference coordinates where the feature point of the object is expected to be located in the stereo images, and coordinates of the feature point of the object, the feature point being acquired in the stereo images;
a difference detection section that acquires a displacement amount of the feature point in the stereo images on a basis of the matching coordinates, acquires a direction difference amount in each of the pan direction and the tilt direction for at least one of the plurality of cameras on a basis of the displacement amount, and generates correction information;
a correction processing section that corrects the stereo images on a basis of the correction information; and
a height estimation section that estimates a height of a cloud contained in the stereo images on a basis of the stereo images corrected by the correction processing section.

2. The cloud measuring system according to claim 1, wherein
each of the plurality of cameras is capable of changing a zoom magnification,
the difference detection section acquires an enlargement/reduction rate of the stereo images on the basis of the matching coordinates, and
the correction information includes the enlargement/reduction rate.

3. The cloud measuring system according to claim 1, further comprising:
an object information storage section that stores object information associated with a reference object having the reference coordinates as a feature point, the reference object being determined as a reference beforehand, wherein
the matching coordinate acquisition section includes an object detection section that acquires, in a case where the stereo images contain the reference object, a combination of the reference coordinates obtained from the object information and coordinates of a feature point corresponding to the reference coordinates in the stereo images, as the matching coordinates.

4. The cloud measuring system according to claim 3, wherein
the matching coordinate acquisition section further includes a cloud shape recognition section that identifies a high cloud contained in the stereo images, carries out matching between a reference image that is a first image included in the stereo images and captured by a first camera of the plurality of cameras and a second image included in the stereo images and captured by a different camera of the plurality of cameras, and acquires, as the matching coordinates, a combination of feature points matched between the first image and the second image.

5. The cloud measuring system according to claim 4, wherein
the cloud shape recognition section identifies the high cloud to acquire the matching coordinates in a case where the object detection section does not detect the reference object.

6. The cloud measuring system according to claim 3, wherein
the information associated with the reference object includes reference image information that is a reference for imaging the object for each of the plurality of cameras, and
the object detection section performs a matching process between each of a plurality of images included in the stereo images and the reference image information for each of the plurality of images to acquire the matching coordinates.

7. The cloud measuring system according to claim 3, wherein
the object detection section identifies a celestial body contained in the stereo images, acquires information associated with the identified celestial body, acquires the reference coordinates that are coordinates of a position where the celestial body is expected to be located in the stereo images, and acquires, as the matching coordinates, a combination of the reference coordinates and coordinates of a position of the celestial body contained in the stereo images.

8. The cloud measuring system according to claim 1, wherein
the difference detection section corrects a control amount in each of the pan direction and the tilt direction for a camera having captured a stereo image for which the direction difference amount exceeding a threshold has been obtained, in a case where the direction difference amount exceeds the threshold specified beforehand, and
the camera control section controls the angle in the pan direction and the angle in the tilt direction for each of the plurality of cameras, according to the corrected control amount.

9. The cloud measuring system according to claim 8, wherein,
the difference detection section resets the correction information associated with the camera having captured the stereo image for which the direction difference amount exceeding the threshold has been obtained, in a case where the control amount is corrected in each of the pan direction and the tilt direction for the camera.

10. A cloud height measuring method for a cloud height measuring system that includes a plurality of cameras each equipped with a lens capable of optically changing a zoom magnification and capable of changing an angle in a pan direction and an angle in a tilt direction, and measures a cloud height by using stereo images including a plurality of images having disparity between each other, the stereo images being captured by a stereo camera, the method comprising:
controlling the angle in the pan direction, the angle in the tilt direction, and the zoom magnification for each of the plurality of cameras to acquire the stereo images captured by the stereo camera;
acquiring a feature point of an object contained in the stereo images, and acquiring, as matching coordinates, a combination of reference coordinates where the feature point is expected to be located in the stereo images and coordinates of the feature point of the object, the feature point being acquired in the stereo images;
acquiring a displacement amount of the feature point in the stereo images on a basis of the matching coordinates, acquiring a direction difference amount in each of the pan direction and the tilt direction for at least one of the plurality of cameras on a basis of the displacement amount, and generating correction information; and
correcting the stereo images on a basis of the correction information, and estimating a height of a cloud contained in the stereo images on a basis of the corrected stereo images.

11. The cloud height measuring method according to claim 10, wherein,
in generating the correction information, in a case where the direction difference amount in either the pan direction or the tilt direction exceeds a threshold specified beforehand, the angle in the pan direction and the angle in the tilt direction are corrected on a basis of the direction difference amount for each of the plurality of cameras to acquire new stereo images, and
processes after acquisition of the stereo images are repeated by using the new stereo images.

12. The cloud height measuring method according to claim 10, wherein
generating the correction information includes acquiring an enlargement/reduction rate of the stereo images on the basis of the matching coordinates, and
the correction information includes the acquired enlargement/reduction rate.

13. The cloud height measuring method according to claim 12, wherein
acquiring the matching coordinates includes carrying out matching of the feature point between a reference image that contains the object for each of the plurality of cameras and each of the plurality of images included in the stereo images to acquire the matching coordinates for each of the plurality of images, and
generating the correction information includes generating the correction information associated with each of the plurality of cameras on the basis of the matching coordinates acquired for each of the plurality of images.

14. The cloud height measuring method according to claim 13, wherein
the object includes at least either a fixed object or a celestial body.

15. The cloud height measuring method according to claim 12, wherein
acquiring the matching coordinates includes identifying a high cloud contained in the stereo images, carrying out matching between a reference image that is a first image captured by a first camera of the plurality of cameras and a second image captured by a different camera of the cameras, and acquiring, as the matching coordinates, a combination of feature points matched between the first image and the second image.
